(19) United States
(12) Patent Application Publication
(10) Pub. No.: US 2024/0395532 A1
(43) Pub. Date: Nov. 28, 2024

(54) VOLTAGE SUPPLY FOR MASS SPECTROMETER

(71) Applicant: Thermo Fisher Scientific (Bremen) GmbH, Bremen (DE)

(72) Inventors: Philipp Cochems, Bremen (DE); Christian Hock, Bremen (DE); Hamish Stewart, Bremen (DE); Marek Niemiec, Bremen (DE)

(73) Assignee: Thermo Fisher Scientific (Bremen) GmbH, Bremen (DE)

(21) Appl. No.: 18/670,620

(22) Filed: May 21, 2024

(30) Foreign Application Priority Data
May 23, 2023 (GB) 2307721.7

(51) Int. Cl. H01J 49/40; H01J 49/02

(52) U.S. Cl. CPC H01J 49/406; H01J 49/022

(57) ABSTRACT

There is described a multi-reflection time-of-flight (MR-ToF) mass analyser for a mass spectrometer, comprising a first and second mirror electrodes respectively configured to operate at a first polarity and at a second polarity. The mass analyser is configured for polarity switching and further comprises: a first regulator coupled to one or more first HV switches and configured to provide an electric potential to the first mirror electrode; and one or more second regulators each coupled to one or more second HV switches, each of the one or more second regulators configured to provide an electric potential to a respective second mirror electrode. The first and second HV switches are configured to swap the polarity supplied to the first regulator and the one or more second regulators. There is further described a regulator comprising a feedback circuit arranged to monitor one or more voltages indicative of a regulated HV voltage supplied at an output, the feedback circuit comprising a first feedback path configured to monitor AC coupled currents on the output and a second feedback path configured to monitor the DC level on the output.

### TECHNICAL FIELD

The present invention relates to a voltage supply for a mass analyser of a mass spectrometer. In particular, the present invention relates to an HV supply for a mass analyser such as a multi-reflection time of flight (MR-ToF) analyser, wherein the HV supply is adapted for supplying electrodes of the mass analyser for performing positive and negative polarity scans of ions.

### BACKGROUND

Mass spectrometry is a long established technique for identification and quantification of a wide range of biological and non-biological materials, often including complex mixtures of large organic molecules.

The majority of mass spectrometric studies are performed via positive ion detection, however many analytes, such as acidic peptides and entire classes of lipids, are far more amenable to negative ionization and detection. For analytes that include a mixture of species some of which are better detected by positive ion detection and some of which are better detected by negative ion detection, it is desirable to switch between positive and negative ionization and detection modes in the mass spectrometer as the species elute from a chromatography system.

Some commercial mass spectrometer instruments are switchable between positive and negative ionization modes within the period of a chromatographic peak, these are generally low resolution triple quadrupole instruments. For higher accuracy mass spectrometers, including High Resolution Accurate Mass (HRAM) analysers, such as time-of-flight (ToF) analysers and orbitraps, fast polarity switching is more difficult. This is because they require very stable, ppm, high voltage electric potentials which are often heavily filtered with corresponding long time delays to charge capacitances and stabilise voltage outputs after switching. During this time, which may be as much as minutes, the mass analyser cannot be used. Hence, performing switching within the duration of a chromatographic peak is not possible because much of the duration of the analysis time of the peak is lost due to the time taken for the mass analyser to switch polarity and for the voltage to stabilise.

Efforts have been made in the prior art to provide high resolution, high accuracy mass spectrometers that can operate to detect positive and negative ions from a sample that do not require polarity switching.

Furutani in U.S. Pat. No. 7,170,052 B2 uses the property that the forces acting on ions are reversed for opposing polarities of the ions. Both ion polarities are simultaneously analysed using two analysers within a hybrid instrument, one operating in each polarity. The two analysers are formed of a doubled up orthogonal time-of-flight (ToF) analyser, where positive and negative ions generated by a source are separated by their opposing directions of ion mobility for different polarities. The separated positive and negative ions are analysed by their respective polarity analysers. Since polarity switching is avoided so are its problems. A similar instrument is described by Wang in U.S. Pat. No. 7,649,170 B2.

U.S. Pat. No. 10,699,888 B2 by Giannakopulos describes an instrument combining an orbital trapping mass analyser and a multi-reflection time-of-flight (MR-ToF) analyser, with a quadrupole mass filter and collision cell for tandem mass spectrometry. This document describes using the slow, high accuracy orbital trapping mass analyser to generate full mass (MS1) scans whilst the fast, sensitive MR-ToF analyser simultaneously provides fragment (MS2) spectra. The MR-ToF analyser is of an opposing mirror type, as described by Grinfeld in U.S. Pat. No. 9,136,101 B2, which is less amenable than the orbital trapping mass analyser to fast polarity switching. The mirror electrode structure requires four stable high voltages, and higher voltages still than the 5 KV of the central electrode of an orbital trapping mass analyser.

Few commercial HRAM instruments support pulsed polarity switching within a single experiment. The notable exceptions are modern orbital trapping mass analyser instruments such as the Orbitrap™ Exploris™ Series (by Thermo Fisher Scientific), which can switch polarity within 500 ms. The Orbitrap™ Exploris™ instrument accomplishes the relatively fast polarity switching by maintaining both positive and negative stable HV supplies to its critical central electrode, and switching between them via a high voltage transistor switch. Such an arrangement is shown in FIG. 1 where positive and negative HV supplies are shown with each connected through a regulator to a transistor switch. The output of the switch is connected to the central electrode of an orbital trapping mass analyser. The outer electrode does not require such high voltage and may be at a virtual ground.

This approach for an orbital trapping mass analyser of switching between stable HV sources allows the number of components and capacitances coupled between the switch and the analyser electrode to be limited, thereby providing a relatively fast speed of polarity switching. However, fast switching power supplies, such as described for orbital trapping mass analyser instruments, are relatively complicated and expensive. For analysers such as an MR-ToF with multiple stable HV supplies, the size and complexity become large, and is further exacerbated by higher voltages requiring even more expensive components.

### SUMMARY OF THE INVENTION

The present invention provides an electronics configuration for polarity switching of HV sources supplied to a mass analyser that is fast and does not result in a multiplication in the number of components required. Firstly, the invention provides new configurations of regulators and switches to provide the switching. Secondly, the invention provides a new regulator that is better able to accommodate switching of HV and settles quickly to reach a desired low ppm voltage error after polarity switching has occurred. By HV we mean voltages greater than around 1000V.

Conventionally, such as for the Orbitrap HV supply arrangement set out above in FIG. 1, each of the positive HV sources are followed by a respective fixed polarity regulator. A HV transistor switch follows to allow the Orbitrap to be switched between the regulated HV positive and negative supplies. Using the same approach for mass analysers such as an MR-ToF analyser requiring multiple high voltages would result in a large number of fixed polarity regulators.

The present invention provides a multi-reflection time-of-flight, MR-ToF, mass analyser for a mass spectrometer, the MR-ToF mass analyser comprising a plurality of mirror electrodes, a first mirror electrode configured to operate at a first polarity and one or more second mirror electrodes configured to operate at a second polarity opposite to the first polarity, the mass analyser configured for polarity switching and further comprising: a first power source configured to provide a first HV supply; a second power source configured to provide a second HV supply; at least two HV switches; a first regulator coupled to one or more first HV switches, the first regulator configured to provide an electric potential to the first mirror electrode; and one or more second regulators each coupled to the one or more second HV switches, each of the one or more second regulators configured to provide an electric potential to a respective second mirror electrode, wherein the first and second HV switches are configured to swap the polarity of electrical potential supplied to the first regulator and the one or more second regulators.

The first power source may be configured in a first bridge configuration, such as a floating polarity power source. The one or more first HV switches may be arranged in the first bridge configuration to reverse the coupling of the first power source in the first bridge configuration to swap the polarity of the electrical potential output to the first regulator. The second power source may be configured in a second bridge configuration, such as a floating polarity power source. The one or more second HV switches may be arranged in the second bridge configuration to reverse the coupling of the second power source in the second bridge configuration to swap the polarity of the electrical potential output to the one or more second regulators.

The first bridge configuration may be a H-bridge arrangement and the one or more first HV switches may comprise four first HV switches. The first power source may be coupled at the centre of the H-bridge arrangement and the four first HV switches may be switchable in two pairs to selectively define a first circuit path coupling the first power source to provide a positive HV voltage to the first regulator and a second circuit path coupling the first power source to provide a negative HV voltage to the first regulator.

The second bridge configuration may be a H-bridge arrangement and the one or more second HV switches may comprise four second HV switches. The second power source may be coupled at the centre of the H-bridge arrangement and the four second HV switches may be switchable in two pairs to selectively define a third circuit path coupling the second power source to provide a positive HV voltage to the one or more second regulators and a fourth circuit path coupling the second power source to provide a negative HV voltage to the one or more second regulators.

The circuit paths may be further coupled to ground or virtual ground.

The HV switches of the bridge arrangements may be configured to be switchable to decouple the power sources from the regulators.

The HV switches of the bridge arrangements may be configured to be switchable to discharge the regulators to ground or virtual ground.

In an alternative arrangement, the first power source may be configured to provide a positive HV supply and the second power source may be configured to provide a negative HV supply. The at least two switches may comprise a first HV switch and a second HV switch, the first and second HV switches each having an output. The first regulator may be coupled to the output from the first HV switch and the one or more second regulators may each be coupled to the output from the second HV switch. The first and second HV switches may be configured to switch between the first and second power sources to swap the polarity of electrical potential at the first mirror electrode and the second mirror electrodes.

The MR-ToF mass analyser may comprise a first voltage pre-scaler arranged to receive the positive or negative HV supply from the first switch and may be configured to provide a HV output having reduced voltage magnitude to the first regulator.

The MR-ToF mass analyser may comprise a second voltage pre-scaler arranged to receive the positive or negative HV supply from the second switch and may be configured to provide respective one or more HV outputs having reduced voltage magnitudes to the one or more second regulators.

The first and/or second voltage pre-scaler may comprise a chain of bi-polar diodes to step the voltage down in magnitude from the voltage or electric potential provided by the positive and/or negative HV supply to the reduced voltage magnitudes.

The second voltage pre-scaler may be arranged to provide at least two HV outputs. A first HV output may be tapped-off from between a first group of bi-polar diodes of the chain of bi-polar diodes and a second group of bi-polar diodes of the chain of bi-polar diodes to step the voltage down to a first voltage magnitude. A second HV output may be tapped-off from between the second group of bi-polar diodes of the chain of bi-polar diodes and a third group of bi-polar diodes of the chain of bi-polar diodes or from between the second group of bi-polar diodes of the chain of bi-polar diodes and one or more resistors to step the voltage down to a second voltage magnitude less than the first voltage magnitude.

The second voltage pre-scaler may be arranged to provide at least three HV outputs, wherein the second HV output is tapped-off from between the second group of bi-polar diodes of the chain of bi-polar diodes and a third group of bi-polar diodes of the chain of bi-polar diodes to step the voltage down to the second voltage magnitude less than the first voltage magnitude, and the third HV output is tapped-off from between the third group of bi-polar diodes of the chain of bi-polar diodes and fourth group of bi-polar diodes of the chain of bi-polar diodes or between the third group of bi-polar diodes of the chain of bi-polar diodes and one or more resistors to step the voltage down to third voltage magnitude less than the second voltage magnitude. The one or more resistors may be used to set the current through the diodes.

The MR-ToF analyser may comprise three second mirror electrodes. For example, the MR-ToF may comprise one first mirror electrode, three second mirror electrodes and a ground electrode. Alternatively, the MR-ToF may comprise other numbers of first and second electrodes.

The present invention provides a regulator or regulator circuit for supplying a regulated HV voltage to an electrode of a mass analyser of a mass spectrometer, the regulator configured for receiving HV voltage of positive or negative polarity, the regulator comprising: an input for receiving a HV voltage from a source; an output for supplying regulated HV voltage to the electrode; one or more reference inputs for receiving one or more reference voltages; a tuning unit for regulating the HV voltage supplied at the output; and a feedback circuit coupled between the output and the tuning unit. The feedback circuit is arranged to monitor one or more voltages indicative of the regulated HV voltage supplied at the output, the feedback circuit comprising a first feedback path comprising a capacitor and configured to monitor AC coupled currents on the output and provide a first feedback signal and a second feedback path configured to monitor the DC level on the output and provide a second feedback signal. The tuning unit regulates the HV output voltage based on the one or more reference voltages and the first and second feedback signals. By receiving a HV voltage of positive or negative polarity we mean that an input of the regulator may receive a HV voltage of positive or negative polarity. Whether the HV voltage is positive or negative polarity may be with respect to a ground or virtual ground which may also be applied to the regulator, for example at a ground terminal.

The tuning unit may comprise a transistor, such as MOSFET, connected between input and the output.

The first feedback path may be configured to filter out DC and/or low frequency leakage currents from the capacitor when the polarity of the HV voltage is switched.

The first and second feedback signals may be combined into a combined feedback signal, such as before being provided to the tuning unit.

The regulator or regulator circuit may further comprise a summing integrator configured to add the one or more reference voltages to the one or more feedback signals and perform integration of the sum.

The one or more reference voltages and one or more feedback signals may be scaled respectively to each other before adding.

The regulator or regulator circuit may further comprise a bridge rectifier, wherein the tuning unit is coupled within the bridge rectifier such that current from the input to the output flows in the same direction through the tuning unit whether the HV output signal is positive or negative polarity.

The feedback circuit may be protected from the HV by being coupled to the tuning unit through an isolating coupler, such as an opto-coupler.

The regulator or regulator circuit may further comprise one or more voltage suppression devices connected across the tuning unit, or bridge rectifier, to limit the voltage dropped across the tuning unit to a maximum predetermined voltage. The one or more voltage suppression devices may be bipolar suppression diodes. The maximum predetermined voltage may be 1000v or less, such as 800, 880 or 900V.

The one or more reference voltages may be generated from a reference voltage unit, the reference voltage unit comprising: a first voltage reference source configured to provide a first reference voltage; and a second voltage reference source configured to provide a second reference voltage. The first voltage reference source may be configured to provide a voltage output more accurate than the second voltage reference source and the second voltage reference source may be configured to provide a voltage output more stable than the first voltage reference source.

The regulator or regulator circuit may further comprise a digital-to-analogue converter (DAC) to scale the output from the second voltage reference to match or correspond in magnitude to the output from the first voltage reference.

The regulator or regulator circuit may further comprise a polarity detector configured to detect whether the regulated HV voltage at the output is positive or negative polarity, or detect whether the combined feedback signal is positive or negative polarity, or detect whether the first feedback signal is positive or negative polarity, and invert the polarity of the combined feedback signal when the HV voltage switches polarity.

The polarity detector may comprise an analogue switch to switch between the combined feedback signal and a polarity inverted combined feedback signal. The analogue switch may be triggered to switch between the polarity inverted combined feedback signal and the combined feedback signal when the regulated HV output switches polarity, such as based on the polarity of the combined feedback signal.

The regulator or regulator circuit may further comprise a discharge detection circuit for detecting a discharge of the HV output voltage. The detection may be based on detecting a sudden voltage change on the output. Alternatively, the detection may be based on an increased current flow through the regulator from the combined feedback signal.

The discharge detection circuit may comprises a window comparator for detecting whether a voltage based on the combined feedback signal is outside a predetermined range. The threshold of the window comparator may be adjustable to determine the size of the discharges.

The regulator or regulator circuit may further comprise an output device for alerting a user that an electrical discharge has occurred when the voltage based on the combined feedback signal is outside the predetermined range. Alternatively or additionally, a counter may be implemented to determine the number and/or frequency of discharges and alerting the user when the number or frequency exceeds a threshold.

The regulator or regulator circuit may further comprise a feedback damping circuit comprising a switch for receiving an input to select between a first combined feedback signal and a second combined feedback signal, the first and second combined feedback signals generated from the combined feedback signal, the second signal having more damping than the first, and the selected one of the first and second combined feedback signals being provided to the tuning unit.

The MR-ToF analyser as set out herein, wherein any of the first regulator or one or more second regulators comprises embodiments of the regulator or regulator circuit as set out herein.

The present invention further provides a mass spectrometer comprising an MR-ToF analyser as set out herein, and/or the regulator or regulator circuit as set out herein.

The present disclosure provides a polarity detector for a regulator or regulator circuit of a mass analyser, the polarity detector configured to detect whether the regulated HV voltage at the output is positive or negative polarity, or detect whether the combined feedback signal is positive or negative polarity, or detect whether the first feedback signal is positive or negative polarity, and invert the polarity of the combined feedback signal when the HV voltage switches polarity.

The present disclosure provides a discharge detection circuit for a regulator or regulator circuit of a mass analyser, the discharge detector configured for detecting a discharge of the HV output voltage based on detecting an increased current flow through the regulator from the combined feedback signal.

The present disclosure provides a feedback damping circuit for a regulator or regulator circuit of a mass analyser, the feedback damping circuit comprising a switch for receiving an input to select between a first combined feedback signal and a second combined feedback signal, the first and second combined feedback signals generated from the combined feedback signal, the second signal having more damping than the first, and the selected one of the first and second combined feedback signals being provided to the tuning unit.

### BRIEF DESCRIPTION OF THE DRAWINGS

Embodiments of the present invention, and aspects of the prior art, will now be described with reference to the accompanying drawings, of which:

FIG. 1 is a schematic diagram of a prior art HV supply configuration for an orbital trapping mass analyser that is switchable between positive and negative operation;

FIG. 2 is a schematic diagram of a dual analyser mass spectrometer comprising a multi-reflection time-of-flight (MR-ToF) mass analyser;

FIG. 3 is schematic diagram of conventional circuitry for generating the four voltages for a fixed polarity MR-ToF mass analyser having four mirror electrodes;

FIG. 4 is a schematic diagram showing how the switchable HV supply arrangement of the orbital trapping analyser of FIG. 1 may be applied to an MR-ToF mass analyser requiring four regulated high voltages as in FIG. 3;

FIG. 5A is a schematic diagram of a HV supply circuit for an MR-ToF analyser, with polarity switching, according to the present invention;

FIG. 5B is a schematic diagram of an alternative HV supply switching scheme for an MR-ToF analyser, according to embodiments of the present invention;

FIG. 6 is a schematic circuit diagram of voltage prescaler;

FIG. 7 is a circuit diagram of an example voltage pre-scaler;

FIG. 8 is simplified diagram of a regulator circuit such as may be used for one of the regulators of FIG. 5A;

FIG. 9 is a schematic block diagram of an improved regulator circuit according to embodiments of the present invention;

FIGS. 10A and 10B together form an example detailed circuit diagram based on the schematic block diagram of FIG. 9;

FIG. 11 is schematic diagram indicating how a bridge rectifier may be connected to regulator transistor of the regulator circuit;

FIG. 12 is an example circuit diagram of full bridge rectifier around the regulator transistor;

FIG. 13 is a schematic diagram of a circuit for detecting and switching polarity of a feedback signal;

FIG. 14 is a schematic block diagram of how a feedback signal with increased damping may selectively be provided;

FIG. 15 is circuit diagram of a discharge detector for detecting unwanted electrical discharge in the mass analyser; and

FIG. 16 is an example circuit diagram showing combining DAC and REF reference voltages with a feedback signal for controlling the regulator transistor.

### DETAILED DESCRIPTION

The present disclosure aims to address the problem of slow settling of polarity switching of HV supplies for HRAM analysers and, in particular, for HRAM analysers requiring multiple high voltages such as multi-reflection time-of-flight (MR-ToF) analysers.

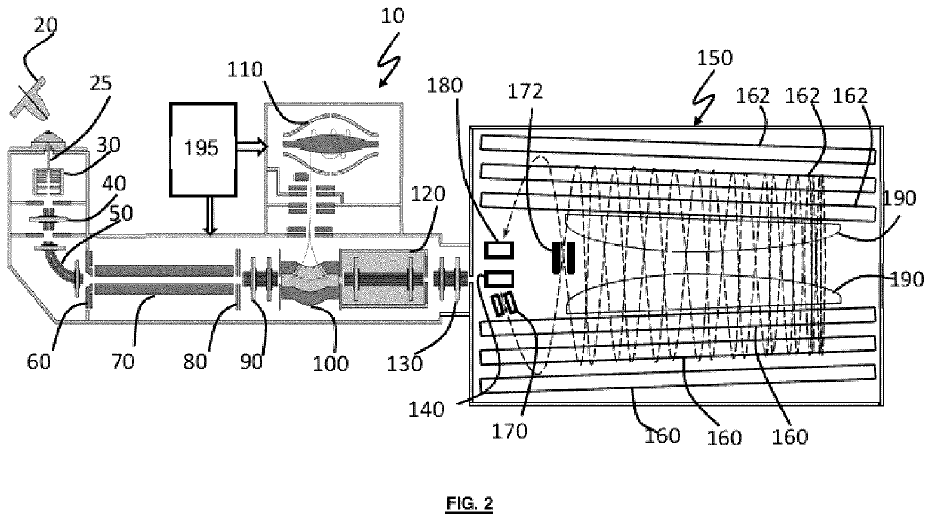

FIG. 2 is a schematic diagram of a dual analyser mass spectrometer in which one of the mass analysers is a multi-reflection time-of-flight (MR-ToF) mass analyser. Before describing the MR-ToF analyser, we briefly describe the mass spectrometer of FIG. 2.

The dual analyser mass spectrometer 10 of FIG. 2 comprises an ion source 20, which may be an electrospray ionization source (ESI source). Sample molecules, e.g. received from a HPLC column, are ionized at the ion source 20. Ions produced from the sample then enter a vacuum chamber of the mass spectrometer 10 and are directed by a capillary 25 into a lens 30 which may be an RF-only S lens 30. The ions are focused by the lens 30 and directed around a curved path such that unwanted molecules such as entrained solvent molecules are removed. The ion focusing may be by an injection flatapole 40 which injects the ions into a bent flatapole 50 with an axial field which guides (charged) ions along the curved path. An ion gate (TK lens) 60 is located at the distal end of the bent flatapole 50. The ion gate may be an ion lens with static fields providing good fringe field properties and transmitting ions cleanly to quadrupole mass filter 70. In some embodiments, the ion gate may control the passage of the ions from the bent flatapole 50 to the quadrupole mass filter 70. The quadrupole mass filter 70 is typically, but not necessarily, segmented and serves as a band pass filter, allowing passage of a selected mass number or limited mass range whilst excluding ions of other mass to charge ratios (m/z). The mass filter can also be operated in an RF-only mode in which it is not mass selective, i.e. it transmits substantially all m/z ions. For example, the quadrupole mass filter 70 may be controlled by controller 195 to select a range of mass to charge ratios to pass of the precursor ions which are allowed to pass, whilst the other ions in the precursor ion stream are filtered (i.e. not allowed to pass). Alternatively, the S lens 30 may be operated as an ion gate and the ion gate (TK lens) 60 may be a static lens.

Although a quadrupole mass filter is shown in FIG. 2, the skilled person will appreciate that other types of mass selection devices may also be suitable for selecting ions within the mass range of interest. The ions selected here may be considered to be precursor ions for later fragmentation.

Following mass selection, ions pass through a quadrupole exit lens/split lens arrangement 80 and into a first transfer multipole 90. The quadrupole exit lens/split lens arrangement 80 may be used to control admission of ions to mass analysers. The first transfer multipole 90 guides the mass filtered ions from the quadrupole mass filter 70 into a curved linear ion trap (C-trap) 100. The C-trap (first ion trap) 100 has longitudinally extending, curved electrodes which are supplied with RF voltages and end caps to which DC voltages are supplied. The result is a potential well that extends along the curved longitudinal axis of the C-trap 100. In a first mode of operation, the DC end cap voltages are set on the C-trap so that ions arriving from the first transfer multipole 90 are captured in the potential well of the C-trap 100, where they are cooled. The injection time (IT) of the ions into the C-trap determines the number of ions (ion population) that is subsequently ejected from the C-trap into the mass analyser.

Cooled ions reside in a cloud towards the bottom of the potential well and are then ejected orthogonally from the C-trap towards the first mass analyser 110. As shown in FIG. 2, the first mass analyser is an orbital trapping mass analyser 110, for example the Orbitrap® mass analyser sold by Thermo Fisher Scientific, Inc. The orbital trapping mass analyser 110 has an off-centre injection aperture and the ions are injected into the orbital trapping mass analyser 110 as coherent packets, through the off-centre injection aperture. Ions are then trapped within the orbital trapping mass analyser by a hyperlogarithmic electric field, and undergo back and forth motion in a longitudinal direction whilst orbiting around the inner electrode. The axial (z) component of the movement of the ion packets in the orbital trapping mass analyser is (more or less) defined as simple harmonic motion, with the angular frequency about the z-axis direction being related to the square root of the mass to charge ratio of a given ion species. Thus, over time, ions separate in accordance with their mass to charge ratio. Ions in the orbital trapping mass analyser 110 are detected by use of an image detector (not shown) which produces a “transient” in the time domain containing information on all of the ion species as they pass the image detector. The transient is then subjected to a Fast Fourier Transform (FFT) resulting in a series of peaks in the frequency domain. From these peaks, a mass spectrum, representing abundance/ion intensity versus m/z, can be produced. This analysis of sample/precursor ions is denoted an MS1 scan because the ions are analysed without fragmentation. In a second mode of operation, ions are fragmented first and then passed to a mass analyser such as the MR-ToF analyser 150. A scan of fragmented ions is known as an MS2 scan.

In this second mode of operation, ions pass through the quadrupole exit lens/split lens arrangement 80 and first transfer multipole 90 into the C-trap 100 and continue their path through the C-trap and into the fragmentation chamber 120. As such, the C-trap effectively operates as an ion guide in the second mode of operation. The fragmentation chamber 120 may be a higher energy collisional dissociation (HCD) device to which is supplied a collision gas, such as an inert gas, for example, argon, nitrogen or helium. Precursor ions arriving into the fragmentation chamber 120 collide with collision gas molecules resulting in fragmentation of the precursor ions into fragment ions. The fragmented ions may be ejected from the fragmentation chamber 120 at the opposing axial end to the C-trap 100 and pass into a second transfer multipole 130. The second transfer multipole 130 guides the fragmented ions into an extraction trap (second ion trap) 140. The extraction trap 140 is a radio frequency voltage controlled trap containing a buffer gas. For example, a suitable buffer gas is argon at a pressure in the range 5×10⁻⁴ mBar to 1×10⁻² mBar. The extraction trap has the ability to quickly switch off the applied RF voltage and apply a DC voltage to extract the trapped ions.

The extraction trap 140 is provided to form an ion packet of fragmented ions, prior to injection into the second analyser. The extraction trap 140 accumulates fragmented ions prior to injection of the fragmented ions into the time of flight mass analyser 150.

The multiple reflection time-of-flight mass analyser (MR-ToF) 150 shown schematically in FIG. 2 is constructed around two opposing ion mirrors 160, 162, elongated in a drift direction. The mirrors are opposed in a direction that is orthogonal to the drift direction. The extraction trap 140 injects ions into the first mirror 160 and the ions then oscillate between the two mirrors 160, 162. The angle of ejection of ions from the extraction trap 140 and additional deflectors 170, 172 allow control of the energy of the ions in the drift direction, such that ions are directed down the length of the mirrors 160, 162 as they oscillate, producing a zig-zag trajectory. The mirrors 160, 162 themselves are tilted relative to one another, producing a potential gradient that retards the ions' drift velocity and causes them to be reflected back in the drift dimension and focused onto a detector 180. The tilting of the opposing mirrors would normally have the negative side-effect of changing the time period of ion oscillations as they travel down the drift dimension. This is corrected with a stripe electrode 190 (to act as a compensation electrode) that alters the flight potential for a portion of the inter-mirror space, varying down the length of the opposing mirrors 160, 162. The combination of the varying width of the stripe electrode 190 and variation of the distance between the mirrors 160, 162 allows the reflection and spatial focusing of ions onto the detector 180 as well as maintaining a good time focus. More details of an MR-ToF analyser 150 are described in US 2015/028197 A1, the contents of which are hereby incorporated by reference in its entirety.

The mass spectrometer 10 is under the control of a controller 195 which, for example, is configured to control the timing of ejection of the trapping components, to set the appropriate potentials on the electrodes of the quadrupole etc. so as to focus and filter the ions, to capture the mass spectral data from the orbital trapping device 110, to capture the mass spectral data from the MR-ToF 150, control the sequence of MS1 and MS2 scans and so forth. It will be appreciated that the controller 195 may comprise a computer that may be operated according to a computer program comprising instructions to cause the mass spectrometer to execute the steps of the method according to the present invention.

The multi-reflection time-of-flight (MR-ToF) analyser may be an opposing mirror type with a pair of mirror electrode structures. The mirror electrode structure may require four stable high voltages. For example, each mirror electrode structure may comprise a series of five electrodes (only three are shown at 160, 162, for each of the electrode structures in FIG. 2). The five electrodes include a ground electrode closest to the axis or drift region on the MR-ToF analyser. For ions possessing around 4 keV, example values the electrode potentials may take are:

| | | |
|---|---|---|
| Ground electrode | 0 | V |
| First electrode | −7341 | V |
| Second electrode | +4607 | V |
| Third electrode | +3663 | V |
| Fourth electrode | +6005 | V |

The high negative potential is used to slow significantly the ions entering the mirror region from the drift region, and the positive potentials reflect the ions away from the mirror region. This assumes the ions entering the mirror region are positive.

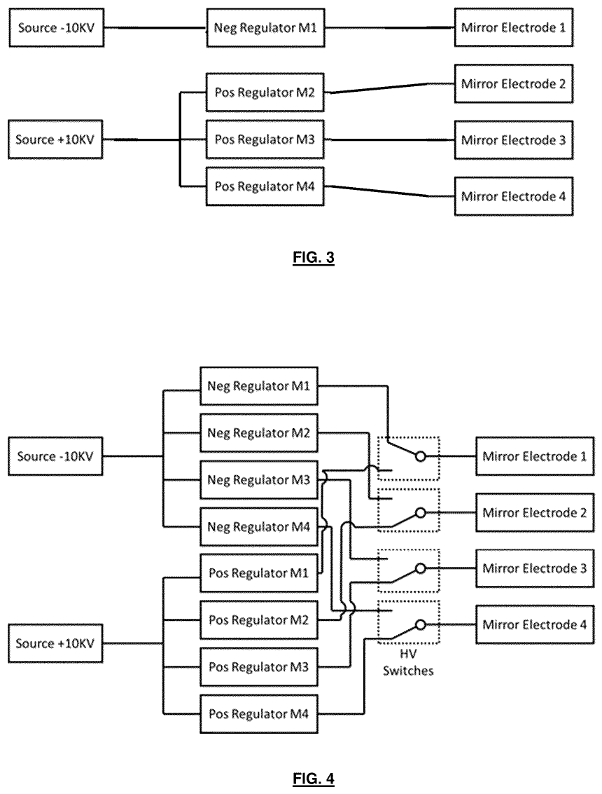

FIG. 3 is schematic diagram of conventional circuitry for generating the four voltages. Negative and positive polarity HV sources are provided, such as having a voltage of +/−10 kV. Regulators are provided between the sources and the mirror electrodes to regulate and set the required voltages. As only one negative voltage is required, there is a single regulator from the −10 kV source providing the required voltage to the first mirror electrode. For example, the negative regulator may provide −7341V to the first mirror electrode. The +10 KV source is used to provide three different voltages respectively each to the second, third and fourth mirror electrodes. A regulator operating at positive voltage is provided for each of the mirror electrodes as they require different voltages.

In general different voltages and different numbers of electrodes may be used. For example, at least one mirror electrode is supplied with a negative voltage and at least two mirror electrodes are supplied with positive voltages.

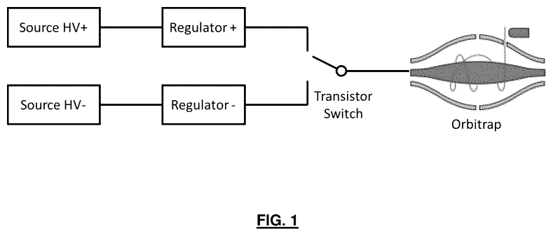

The arrangement of sources, regulators and mirror electrodes shown in FIG. 3 does not include the possibility of switching polarity for analysing opposite polarity ions. To achieve switching of polarity, similarly to that shown for the orbital trapping analyser of FIG. 1, switches are required to switch the polarity of the voltage applied to the mirror electrodes.

One approach for including switches is to include switches following the regulators in a similar way as shown for the orbital trapping analyser of FIG. 1. For the orbital trapping analyser this arrangement provides fast polarity switching by maintaining both positive and negative high voltage supplies to its central electrode and switching between them via a high voltage transistor switch. The number of components and capacitances between the switch and the electrode is limited to achieve the high speed switching. For example, positive and negative regulators are provided at the HV source side of the switch to avoid having to switch polarity of a slow response regulator. The number of components is doubled by providing the positive and negative polarity HV supplies, as compared to a system that switches polarity of an unregulated HV supply.

FIG. 4 shows a similar approach applied to an MR-ToF analyser requiring four regulated high voltages as in FIG. 3 but now with polarity switching. The increased number of regulated voltages increases the complexity significantly. In the same way as for FIGS. 1 and 3, one positive HV source and one negative HV source are provided, for example, at −10 kV and +10 kV. Four regulators are provided connected to the negative HV source and four regulators are provided connected to the positive HV source. HV switches are provided between the regulators and the mirror electrodes. A switch is provided for each mirror electrode. The switches switch between connecting the mirror electrodes to negative or positive voltages supplied from the regulators. With the switches in the positions shown in FIG. 4 the first mirror electrode is supplied with a negative voltage and the second, third and fourth electrodes are supplied with different respective positive voltages. Here the same voltages configuration is supplied as in FIG. 3. However, if all of the switches in FIG. 4 are switched, the polarity of voltage supplied to the mirror electrodes is reversed and so can be used for analysing opposite polarity ions. By maintaining voltages and regulators at positive and negative voltages for each electrode, they can be switched rapidly minimizing deadtime. However, the doubling up of the number of regulators and components therein is a significant increase in the number components and cost when four voltages are required. For example, HV or high stability feedback resistors in the regulators are expensive and eight sets are required for the eight regulators.

The present invention provides an improved HV supply circuit for an MR-ToF mass analyser. The circuit and its principles may also be used for other mass analysers requiring a number of regulated high voltages.

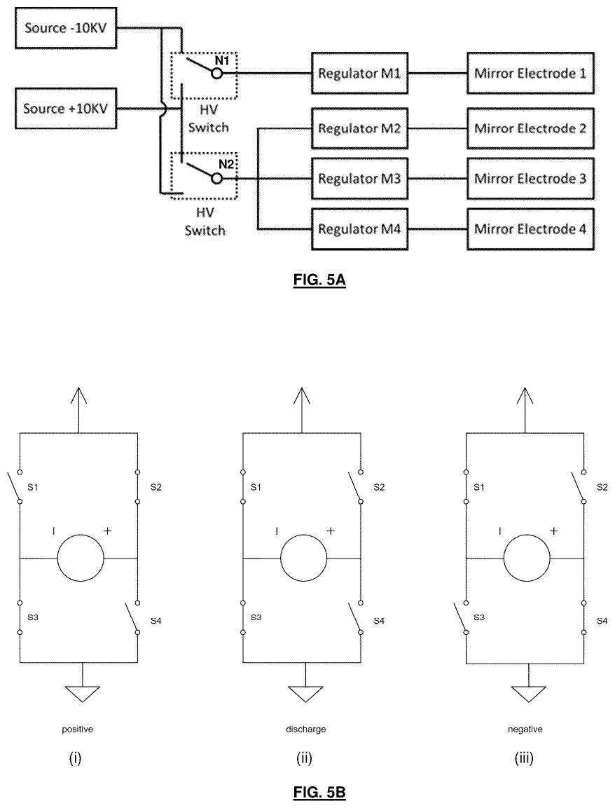

FIG. 5A is a schematic diagram of a HV supply circuit for an MR-ToF analyser according to the present invention. The circuitry includes two switches and four regulators and so requires less components than that of FIG. 4. The switches are provided after the HV sources and before the regulators, with the regulators outputting to the mirror electrodes.

The schematic diagram of FIG. 5A is for supplying a single HV voltage of a first polarity and three HV voltages of a second polarity to an MR-ToF. Other combinations of the number of HV voltages of each polarity are possible. For example, only one or two voltages of a second polarity may be provided if sufficient for the mass analyser. In one example, the MR-ToF mass analyser may comprise a plurality of mirror electrodes, such as a first mirror electrode configured to operate at a first polarity and one or more second mirror electrodes configured to operate at a second polarity opposite to the first polarity

The arrangement of FIG. 5A comprises a first power source configured to provide an HV supply of a first polarity such as negative polarity and a second power source configured to provide an HV supply of a second polarity such as positive polarity. First and second HV switches are provided. Each HV switch has two inputs and one output. The two inputs are respectively connected to the first and second power sources. The switches are configured to switch between connecting the first and connecting the second power sources to the output of the switch such that the switches are configured to switch between providing positive and negative HV. The switches are preferably configured to be switched together such that at any time the output of no more than one of the switches is connected to the first power source and the output of no more than one of the switches is connected to the second power source.

The schematic diagram of FIG. 5 shows four regulators. A first regulator M1 is coupled to the output from the first HV switch and is configured to provide an electric potential to the first mirror electrode. Second, third and fourth regulators are each coupled to the output from the second HV switch. Each of the second, third and fourth regulators, M2, M3 and M4, are configured to provide electric potentials to respective second mirror electrodes. For example, second regulator M2 is coupled to second switch and configured to provide an electric potential to mirror electrode 2. Third regulator M3 is also coupled to second switch and configured to provide an electric potential to mirror electrode 3. Fourth regulator M4 is coupled to second switch and configured to provide an electric potential to mirror electrode 4. Where multiple regulators are connected to one of the switches they are connected in parallel. For example, regulators M2, M3, and M4, are connected in parallel to the second switch. The electric potentials supplied to the mirror electrodes from different regulators may have different magnitudes. All regulators connected to a first switch (only one is shown in FIG. 5A) may be considered to be regulators of a first type and all regulators connected to a second switch may be considered to be regulators of a second type.

First and second types of regulator are configured to be compatible with positive and negative voltages received from the regulators. The first and second HV switches are configured to switch between the first and second power sources to swap the polarity of electrical potential at each of the mirror electrodes. By swapping the polarity of the electric potential at the mirror electrodes the mass spectrometer may analyse ions of opposing polarities.

FIG. 5A shows that the regulators M2, M3 and M4 are all coupled to the second HV switch and are coupled to respective different mirror electrodes to supply electric potentials thereto. As mentioned above, it is desirable that the electric potentials supplied to the mirror electrodes will have different magnitudes. For example, they may take the values +4607 V, +3663 V and +6005 V. The regulators themselves may scale the voltages to the required values from the voltage received from the power supply which may be 10 kV. However, transistors commonly can only handle up to around 1500 V so a pre-scaler (not shown in FIG. 5A) may be used to reduce the magnitudes of the voltage into the ranges needed. The regulator and/or pre-scaler should be able to accommodate switching of polarity of the HV such as when the HV switches from the −10 kV to +10 kV.

FIG. 5B is a schematic circuit diagram of an alternative switching scheme. The figure shows the same circuit switched differently to provide three modes, as shown by i), ii) and iii). The circuit comprises a floating HV voltage source configured at the centre of a bridge circuit. The bridge circuit shown is an H-bridge circuit which comprises four switches, each of the switches arranged on a leg of the bridge circuit. Hence, the four switches form two parallel paths from an output, indicated by the arrow at the top of the figure, to ground or virtual ground, indicated by the triangle at the bottom of the figure. The two parallel paths are linked between the two switch pairs by the HV voltage source. The voltage source has positive polarity and negative polarity terminals or outputs. The four switches are arranged to swap the polarity outputs or terminals that are respectively coupled to the regulator and to ground so as to swap the polarity voltage supplied to the regulators.

A first power source may be used to supply HV voltage to the first mirror electrodes and a second power source may be used to supply HV voltage to the one or more second mirror electrodes. In other arrangements each HV power source may supply one or a group of mirror electrodes.

With reference to FIG. 5A the switching scheme of FIG. 5B replaces the sources and HV switches in FIG. 5A. The output from switching may couple to the regulators and mirror electrodes of FIG. 5A at nodes N1 and N2. For example, a first HV source and bridge circuit may supply first regulator and couple to node N1, and a second HV source and bridge circuit may supply the one or more second regulators and couple to node N2. The sources may be 10 KV sources but each is dedicated to a set of regulators and mirrors.

The switching circuit of FIG. 5B may be preferred over the switching arrangement of FIG. 5A because the HV voltage sources can be chosen to match the power requirements of the set of mirror electrodes to which they are dedicated. This is different to the arrangement of FIG. 5A in which each voltage source has to be able to supply the maximum power of either set of mirror electrodes. Hence, both voltage sources have to be able to supply enough power for the three second mirror electrodes, whereas in the arrangement of FIG. 5B only the dedicated voltage supply is required to do so.

In the switching circuit of FIG. 5B the switches only need to handle 10 kV whereas the switches of FIG. 5A have to handle 20 kV. Although the arrangement of FIG. 5B requires twice as many switches as FIG. 5A, the number of transistors is the same and the benefit of the lower voltages requirements of the switches outweighs the disadvantage of having more switches.

As mentioned above, FIG. 5B shows three switch modes for the circuit. The four switches are labelled S1-S4. In circuit mode (i), the switches S1 and S4 are open and switches S2 and S3 are closed such that the positive terminal of the voltage source is coupled to the regulator and the negative terminal is coupled to ground. In circuit mode (iii), the switches S2 and S3 are open and switches S1 and S4 are closed such that the negative terminal of the voltage source is coupled to the regulator and the positive terminal is coupled to ground. In the third mode, shown as (ii), the switches S1 and S3 are closed and S2 and S4 are open. In this way the regulator is connected directly to ground and the voltage source is decoupled from the output. This allows the regulator to discharge to ground, for example, when switching polarity, and the HV voltage source remains turned on for fast response.

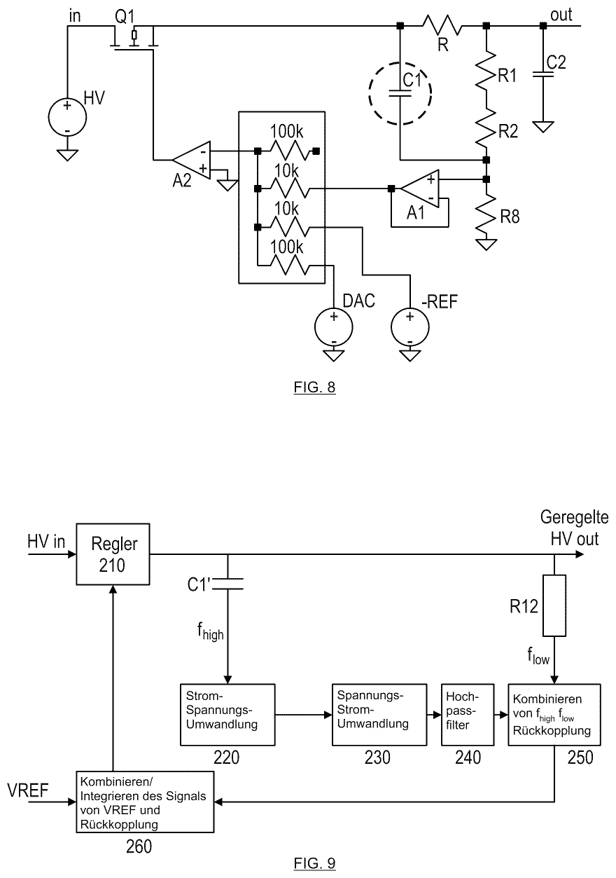

We now compare the circuits of FIGS. 5A and 5B. In the configuration of FIG. 5A, with reference to regulator circuit shown in FIG. 8, at the time of polarity switching, such as from −10 kV to +10 KV, a capacitor C2 is charged to −10 kV and then the input of resistor R would be connected to +10 kV while C2 is still charged to −10 kV. That means that R also needs to be able to handle 20 kV, which makes not only R much larger, but also the surrounding electronics. Another problem is that the +10 kV voltage source not only needs to charge C2 to +10 kV, it also needs to discharge it from −10 kV in a first step. The circuit of FIG. 5B avoids this problem. For FIG. 5B, switching polarity may comprise the following steps:
1. Disconnect the HV source from the output;
2. Connect the output to ground by closing S1 and S3 (S2 and S4 would also be possible) and wait for the regulator (and electrode) circuit components to discharge; and
3. Connect the source in the opposite polarity to the output.

The configuration of FIG. 5B allows for a much higher discharge current than the HV source could provide and that leads to faster switching times.

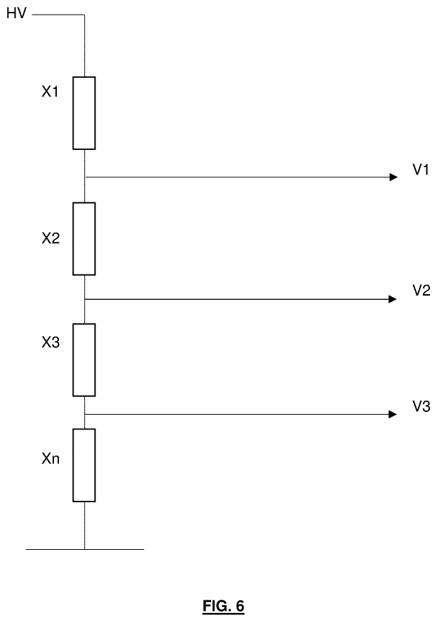

FIG. 6 is a schematic diagram of a pre-scaler. The pre-scaler acts like a potential divider. However, it should be able to accommodate high voltages and should also be able to switch rapidly. The pre-scaler shown in FIG. 6 is able to scale the HV received from the power supply and output three reduced magnitude voltages respectively for supplying to the second to fourth mirror electrodes. For providing three different voltages, the pre-scaler comprises four elements X1, X2, X3 and Xn to scale the voltages. The three outputs are tapped from between the four elements. The highest magnitude voltage is tapped from the between the first element X1 receiving the HV from the switch and the next element, X2. The second highest magnitude voltage is tapped from the between the second element X2 and the third element, X3. The third highest magnitude voltage is tapped from between the third element, X3, and the next element Xn which may connected to ground. Other numbers of elements and voltages output to mirrors may be provided, such as depending on the requirements of the electrodes of the mass analyser. The elements X1 to Xn may be resistive or they may be diodes.

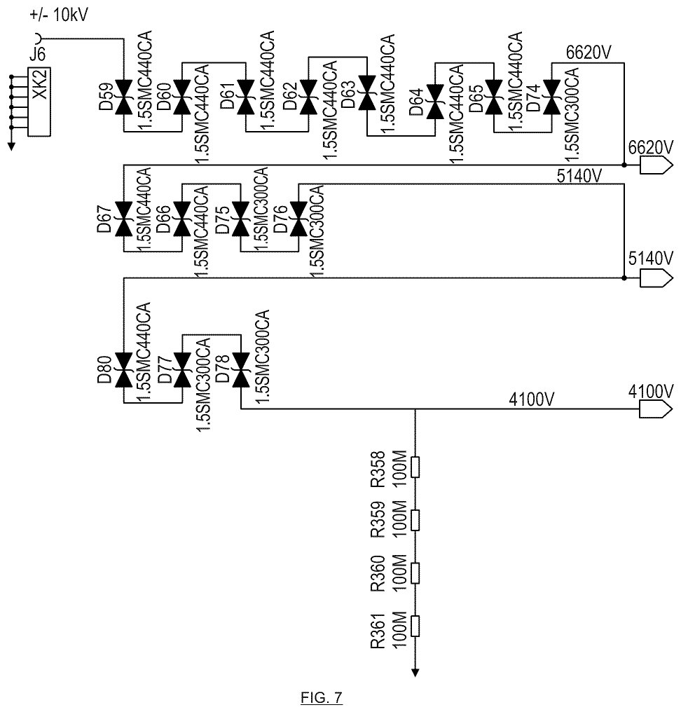

FIG. 7 is an example circuit diagram of pre-scaler. In this example the elements between the HV received from the HV switch and the lowest of the HV outputs are provided by chains of bipolar transient suppression diodes. Such diodes are usually used to protect circuits against high voltage transients and so are able to handle high voltage. As they are also bipolar they are able to handle high voltages of both polarities. Bipolar transient suppression diodes limit or clamp the voltage applied across them. In the example shown in FIG. 7 eight transient suppression diodes are coupled in series between the +/−10 kV received from the HV switch and the largest magnitude scaled voltage. The number and rating of the bipolar suppression diodes used is selected to provide the required voltage magnitude at the output. In the example, seven 440 V rated diodes and one 300 V rated diode are used which result in scaling of the maximum magnitude output to 6620 V. This is around 10% higher than the value required at the mirror electrode to allow for a voltage drop across the regulator, such as across the transistor of the regulator. Between the first and second output voltages is provided a second chain of bipolar suppression diodes. In the example of FIG. 7 four bipolar suppression diodes are included to scale the output to 5140 V. Between the second and third output voltages is provided a third chain of bipolar suppression diodes. In the example of FIG. 7 three bipolar suppression diodes are included to scale the output to 4100 V. Between the third output voltage and ground are provided a chain of high value resistors to set the current flow to ground. The current flow is set to a defined level to maintain operation of the diodes. The current level is set to avoid a high current flow putting a high load on the HV supplies requiring high power. On the other hand, the current level must not be too low because a very low current flow will increase the noise generated by the diodes. In the example of FIG. 7 the chain of high value resistors comprises four 100 MΩ resistors. The resistors are coupled on the ground side rather than the HV side, with diodes on the HV side. The bipolar suppression diodes can carry high currents and the output can be quickly discharged and changed to the opposite polarity, without a current limit that would occur if resistors were included at the HV end of the path.

The examples of FIGS. 6 and 7 provide three scaled voltage outputs for the three mirror electrodes. Other numbers of outputs may be provided and different values may be provided. For example, only one or two voltage outputs may be provided depending on the requirements of the mass analyser.

FIG. 8 is simplified diagram of a regulator circuit as may be used for one of the regulators in FIG. 5A. The regulator circuit may need to be combined with a bridge circuit to accommodate switching of polarity. In the circuit of FIG. 8 an HV is received at “in”, regulated by transistor Q1 and supplied to output “out” which may be coupled to one of the mirror electrodes. The transistor Q1 which regulates the output is controlled by a feedback loop which is fed from the output line. The regulator Q1 may be considered to be, or form part of, a tuning unit because it tunes the output voltage to the desired level. For conventional regulators, the arrangement of resistors R1, R2 and R8 would be used to monitor to the voltage at the output. Resistor R and capacitor C2 provide low pass filtering to the output signal. R1, R2 and R8 act as a potential divider with the voltage from the divider being fed, via a buffer amplifier A1, to a resistor network and operational amplifier A2 which regulates the transistor Q1. Resistors R1, R2 and R8 take large values to limit current flow through them. The voltages provided by DAC and REF are added together along with the feedback signal at amplifier A2. The two 100 kΩ and two 10 kΩ resistors provide weighting to the incoming voltages such that the voltage from the DAC reference has ten times the weighting to that of the reference REF and the feedback signal. The top 100 KΩ resistor in the figure isn't needed. The use of the two references REF and DAC will be described further later herein, but briefly REF is an accurate reference voltage and DAC is based on a stable reference voltage. The output of amplifier A2 is coupled to the gate of transistor Q1 to regulate the output. In this way the voltage output from the regulator circuit is maintained stable with closed loop feedback to variations.

The circuit of FIG. 8 includes capacitor C1 in parallel to resistors R1 and R2. The capacitor C1 provides a non-DC feedback path and stabilizes the regulator. However, the capacitor C1 causes problems in the present HV switching case, which also requires ppm stability, as we will discuss further below. As mentioned above, to limit currents flowing at such high voltages, high value resistances are used. This high value resistors are only able to drive the parasitic capacitances on the input of A1 with a very limited bandwidth. A reduced feedback bandwidth should be compensated by a higher regulator time constant, but that leads to poor noise reduction and very long settling times. The addition of capacitor C1 in parallel to the feedback resistors R1, R2 creates a low impedance feedback path for higher frequencies (AC) and can stabilize the regulator even with short time constants. This leads to faster settling times and better noise reduction. A difficulty is that the capacitors used are not ideal, having leakage and problematic dielectric absorption (DA). Dielectric absorption (DA) is caused by a delayed polarization of the dipoles in the dielectric material. To a small extent the capacitor may be considered to have a voltage memory. The effect depends on the material used for the capacitor. Foil resistors are one of the best capacitors and show very low DA effects. However, even with this kind of capacitor the feedback configuration is not effective for accurate polarity switching. When polarity switching has occurred, capacitor C1 suffers from dielectric absorption (DA) which results in a small DC leakage current through the capacitor after the switching has occurred. The leakage current, although small, provides a small additional DC input to A1 causing a drift in output voltage. It takes many seconds, for example 2000 seconds, for the current through the capacitor to reduce to a low enough level to achieve the required high stability of output voltage for a HRAM mass analyser. The required stability may be a less than 1 ppm shift in output voltage.

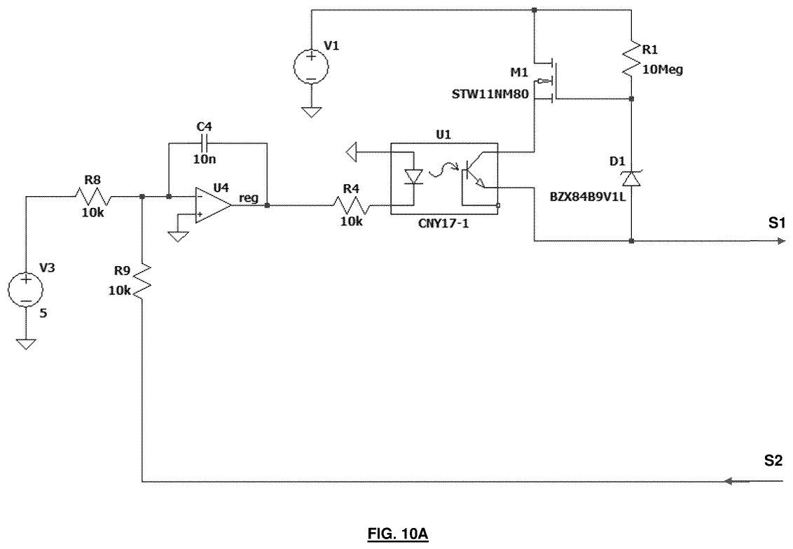

FIG. 9 is a schematic diagram of a improved regulator circuit according to embodiments of the invention. The circuitry of the present invention decouples the AC feedback path of the regulator from the DC feedback path to overcome the leakage effect of the capacitor. This is achieved by providing a separate path for the AC coupled currents followed by filtering out of the low frequency parts including the leakage current, and then combining with any DC or low frequency feedback from the DC feedback path. The combined AC coupled and DC feedback is then combined with a reference in a similar way to the circuit shown in FIG. 8.

Referring in more detail to FIG. 9, regulator 210 corresponds to transistor 210 in FIG. 8. Capacitor C1′ in FIG. 9 corresponds to capacitor C1 in FIG. 8. Resistor R12 corresponds to resistors R1 and R2 in FIG. 8. As in FIG. 8, the capacitor C1′ in FIG. 9 provides an AC feedback path. C1′ is the capacitor that suffers from dielectric absorption and has a leakage current when polarity is switched. R12 provides the DC or low frequency feedback path. FIG. 9 also includes two blocks 220 and 230, of which block 220 converts the AC feedback current through the capacitor to a voltage, which is then later converted back to a current at block 230. This conversion to a voltage is used to communicate or transport the AC feedback signal with low interference across the circuit board or to another circuit board. Such a low interference communication provision is helpful here as some parts of the feedback and voltage control circuitry may be located in an oven or otherwise temperature controlled. When the voltage signal is close to the regulator it is converted back to current at block 230. Block 240 is a high pass filter which filters out DC signals including the DC leakage current of the capacitor C1′ resulting from polarity switching and caused by dielectric absorption (DA). At block 250 DC feedback from the HV output is combined with the AC feedback that has had the DA leakage current removed. As the AC feedback signal has been converted back to current, it mimics the behaviour of the capacitor C1 in the circuit of FIG. 8. At block 260 the combined AC and DC feedback signals are combined or integrated with the reference signal VREF and the resulting signal is fed to the regulator or tuning unit 210 to control the HV output. Although in FIG. 9 only one reference VREF is mentioned, alternatively the two references REF and DAC discussed for FIG. 8 may be used.

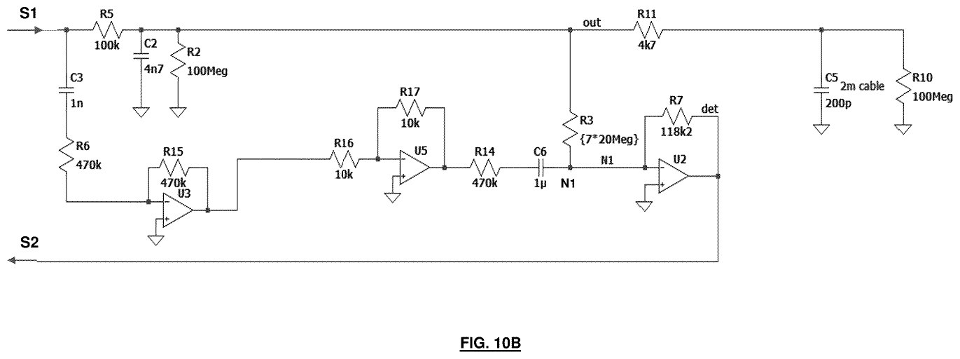

FIGS. 10A and 10B together form a detailed circuit based on the schematic block diagram of FIG. 9. FIGS. 10A and 10B combine to form a diagram of a single circuit. Signals S1 and S2 which are output/inputs from the portion of the circuit shown in FIG. 10A correspond to the inputs/outputs for the portion of the circuit shown in FIG. 10B.

In FIG. 10A the voltage to be regulated, such as 6500 or 6620 V is illustrated as supplied by voltage source V1. The signal that is output from the regulator to the mirror electrode is identified as S1 in FIG. 10A, although with some further components shown in FIG. 10B the actual voltage will differ a little. The voltage to be regulated may be received from a pre-scaler such as discussed in relation to FIGS. 6 and 7 but is unregulated. Based on the embodiment of FIG. 10A the regulation is performed by MOSFET transistor M1, optocoupler U1, Zener diode D1 and resistor R1. In the embodiment shown R1 takes the value of 10 MΩ, although other values may be used. Additional components may be included to filter the Zener voltage to reduce noise, as will be mentioned with reference to FIG. 12. The input voltage path from V1 is connected to the drain of the transistor and also to the resistor R1. The source of the transistor is connected to the optocoupler which in turn is connected to the output line. The resistor R1 is connected to the Zener diode and the Zener diode is also connected to the output line. A connection is also made between the Zener diode and gate of the transistor. This configuration is similar to a cascode circuit, which is normally used to minimize the capacitance effects of a fast transistor. Here the circuit is used to allow the optocoupler to handle voltages up to around 1500 V. Current flow is mostly through the transistor M1 and optocoupler U1. The current that is allowed to flow through the optocoupler U1 is controlled by a voltage from the feedback loop which is partly formed by signal S2 shown as received from the circuit portion shown in FIG. 10B. The resistor R1 and Zener D1 set a voltage operating point for the transistor which is largely fixed but varies slightly with changes in output current controlled by the optocoupler. The transistor M1 and optocoupler U1 may be considered to be a tuning unit. The Resistor R1 and Zener diode D1 may additionally be considered to be part of the tuning unit.

The optocoupler is used to isolate the feedback loop from the HV. The input of the optocoupler is working close to 0V and the output is on HV. The HV electric potential at the transistor M1 and provided at S1 is at several kV, for example, around 6500 or 6620 V. The optocoupler isolates the feedback loop from this HV. The Zener diode D1 provides a largely fixed point for operation of the transistor. Other components in FIG. 10A are part of the feedback loop, such as R8, R9, C4, R4 and voltage V3, and will be described after describing FIG. 10B.

FIG. 10B shows the two feedback paths, one for AC and high frequency currents and the other for DC and low frequency currents. Both paths are connected to the output line to monitor the output voltage. The AC and high frequency path is coupled to the output line through capacitor C3. This is equivalent to capacitors C1 and C1′ in FIGS. 8 and 9 respectively. It is this capacitor that suffers from leakage due to dielectric absorption when polarity switching occurs. Following capacitor C3 is a resistor R6 which forms part of an inverting amplifier formed by operational amplifier U3 with resistors R15 and R6. The operational amplifier arrangement of U3 also operates as a current-to-voltage converter such that the feedback signal can be transmitted or communicated across the circuit board or to another circuit board as a voltage with low interference. A second inverting amplifier arrangement U5 follows U3 which is provided to return the polarity of the signal back to that tapped off the output line by C3. The AC feedback back path is then joined by the DC or low frequency feedback path at node N1. Resistor R3 is on the path from the output line between node N1 and output line. R14 and C6 are on the path from operational amplifiers U3 and U5 with the capacitor C6 closest to the node N1 and R14 is in series with C6. Resistor R14 converts the voltage feedback signal back to current now that it has crossed the circuit board and is close to the regulator or tuning circuit. C6 and R3 form a high pass filter in one direction, decoupling the leakage from capacitor C3 from being carried further into the feedback loop. The filter formed by C6 and R3 also allows low frequency components to pass through to the feedback loop from the HV output line (but low frequencies or DC from dielectric absorption at C3 do not pass here). The resistor R3 is large or may be a combination of a number of resistors such as seven 20 MΩ resistors in series. R3 is used to buffer the feedback circuit from the HV on the output line. In principle, C6 may also be susceptible to dielectric absorption and leakage current, but the low voltage across it on the feedback path mean that its effect is insignificant.

Connected to node N1 is also an operational amplifier U2 which is connected in a similar manner to A1 in FIG. 8 and buffers or amplifies the combined AC and DC feedback voltage, which has now had the leakage from the HV capacitor C3 filtered out. The feedback voltage, now represented as S2, is returned to the portion of the circuit show in FIG. 10A and we will describe this shortly. On the output line in FIG. 10B are also shown a number of other components such as C2, R2, R11, C5 and R10. These represent a mix of filtering and circuit simulation representations used for convenience in a simulation such as Spice.

Returning to FIG. 10A, the combined feedback signal S2 is combined or added with a reference voltage and input to an integrating amplifier U4. The reference voltage is represented by V3 in the figure but may be more complex than a simple reference as we will describe in later figures. The voltage from feedback signal and that from reference V3 are combined in a similar manner to the combining of voltages at amplifier A2 in FIG. 8. Since both voltage paths are combined through equal value resistance R8 and R9, which here are 10 kΩ, they take equal weights in the feedback. Other weightings may be used. U4 adds the combined feedback signal S2 with the reference voltage, and capacitance C4 across amplifier U4, which may take the value of 10 nF, integrates the signals over a time constant. An integrator configuration is used because it generates a high amount of gain for low frequencies and allows for precise regulation. The integrated signal is supplied via resistor R4 to the input side of optocoupler U1 which controls the current through the MOSFET M1 and hence the voltage on the output line.

The combination of the optocoupler and large value resistors R3 buffers the feedback circuit from the HV on the output line which may be kV, for example 6500 or 6620V. This allows the voltage in the feedback circuit to be much lower.

The circuit of FIG. 8 is a simplified schematic that is used for explanation of the concepts disclosed herein. However, the circuit of FIG. 8 is only usable for positive voltages and is shown in this simplified form to explain the principles of how the regulation and the AC feedback could operate.

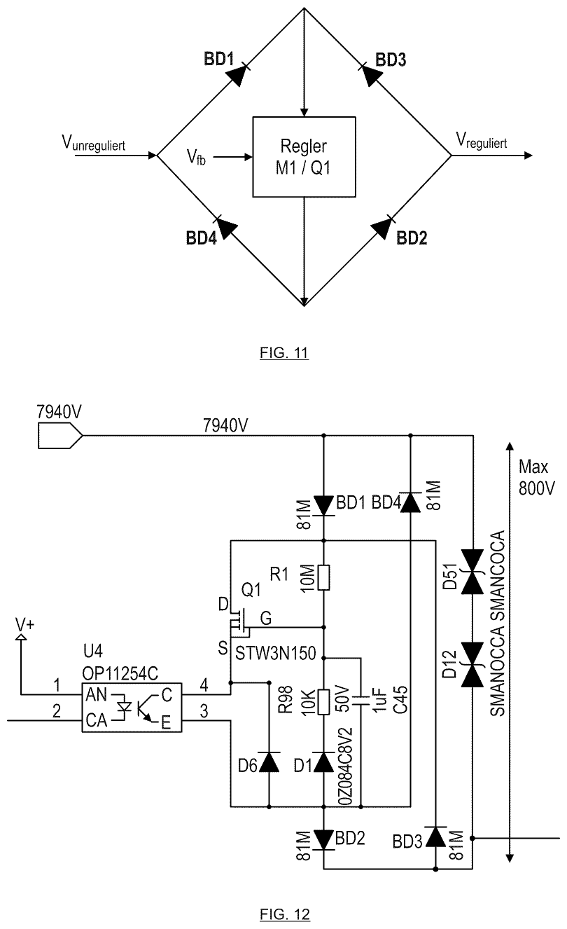

FIGS. 10A and 10B show a more detailed regulator circuit which takes into account the effect of polarity switching on the HV capacitor (C3, C1 or c1′) and takes steps to remove the leakage caused by dielectric absorption. However, so that the regulator circuit works for both polarities, a rectifier such as a full bridge rectifier may be built around the tuning unit, that is around the regulator transistor Q1 or M1. FIG. 11 is schematic diagram indicating how such a bridge rectifier may be connected around the regulator transistor Q1 (in FIG. 8) or M1 (in FIG. 10A). The full bridge rectifier may comprise four diodes connected in a bridge arrangement. The diodes may be considered to be in two pairs, with bridge diodes BD1 and BD2 conducting when current flows in the forward direction and bridge diodes BD3 and BD4 conducting when current flows in the reverse direction. The input to the bride rectifier is the unregulated voltage such as received from the voltage pre-scaler and the output is the regulated voltage such as may be supplied to mirror electrodes of the mass analyser. The regulator or tuning unit is still controlled by a feedback loop such as described herein. In this arrangement the current will always pass the transistor in the same direction, whichever polarity HV is being supplied. A comparator circuit (not shown in FIG. 11) may also be included to detect whether the feedback signal is positive or negative and to set the feedback signal to the correct polarity for the polarity of the HV such that the feedback correctly converges the output to a desired level. If the feedback has the wrong polarity the output will diverge from the desired level.

FIG. 12 is a circuit diagram of full bridge rectifier around the regulator transistor. The optocoupler U4 and Zener diode D1 which control the regulator transistor Q1 are also shown. The diodes of the bridge rectifier are again identified as BD1-BD4. Resistor R1 used in combination with the Zener diode D1 which sets the operating point of the transistor is again identified as R1. In the figure some additional components are included such as diode D6, resistor R98 and capacitor C45. These provide additional protection, filtering to remove noise of the Zener D1, and compatibility for polarity switching. Also shown in FIG. 12 are a pair of series connected bipolar suppression diodes D12 and D51. Such diodes limit the voltage that can be applied across them. In the example of FIG. 12 each of the diodes of the pair limits the voltage across it to 400V such that the pair of diodes set a maximum voltage across them at 800V. These diodes are connected in parallel with the bridge rectifier BD1-BD4 and transistor regulator arrangement and hence limit the voltage across them. Other numbers or values of bipolar suppression diodes may be used to provide an appropriate maximum voltage across the bridge rectifier and transistor regulator or tuning unit as required.

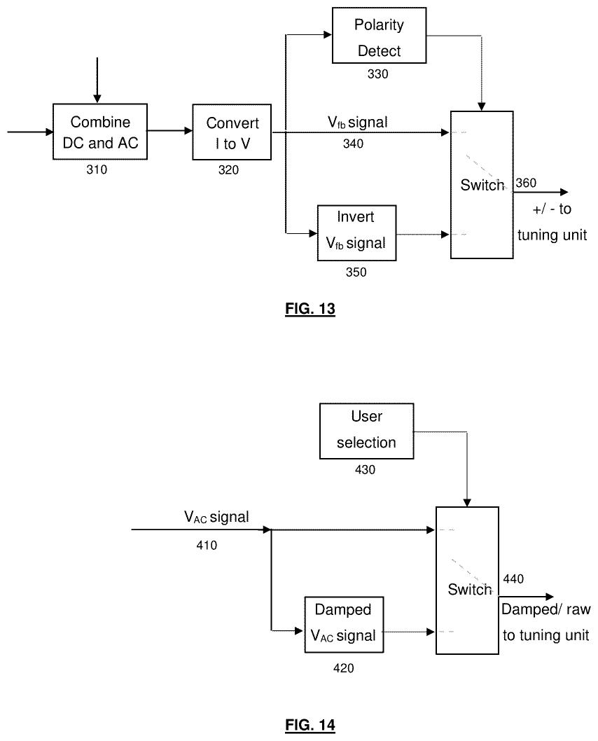

As described above, when polarity of the HV is switched it may be necessary to also switch polarity of the feedback signal. FIG. 13 is a schematic diagram of a circuit for detecting and switching polarity of the feedback signal. At block 310 the DC and AC feedback signals are combined. This corresponds to block 250 in FIG. 9 and node N1 in FIG. 10A. At block 320 the feedback signal which is a current is converted to a voltage. This is in line with FIG. 10B. The polarity of the feedback signal voltage is detected at block 330. The feedback voltage, V_{fb}, is inverted at 350, such as using an inverting operational amplifier configuration. The feedback voltage V_{fb} from 340 and the inverted feedback voltage from block 350 are provided as inputs to an analogue switch 360. The analogue switch can switch between outputting the inverted and non-inverted feedback voltage. The signals switched by the analogue switch are low voltages. The switching is used to keep the feedback signal with the correct polarity for the feedback to converge the HV output to the desired stable value. The switch is controlled by the polarity detector depending on the detected polarity of the feedback signal. For example, if the polarity is negative then the switch may be controlled to output the inverted feedback signal and if the polarity is positive the non-inverted feedback signal may be output from the switch 360. Alternatively, the feedback switching may be oppositely configured. The output from the switch 360 is combined with the VREF signal such as at block 260 in FIG. 9 and used to control the regulator 210. Methods other than those shown in FIG. 13 may be used for detecting and switching polarity of the feedback signal.

Other functions may be incorporated using similar circuits as described for FIG. 13. For example, a feedback signal with increased damping may be included and/or a discharge detector may be included.

FIG. 14 is a schematic block diagram of how a feedback signal with increased damping may selectively be provided. The feedback signal, such as VAC, that results from the AC feedback is received at 410. The signal is directed to analogue switch 440. The signal is also fed into a damping unit 420 to generate a damped signal. This may be an integrator circuit that integrates over a certain time constant. The damped signal is also fed to the switch 440. A user input received at 430 may be used to control the switch. The switch is switched between the damped signal and normal feedback signal based on the user selection. The output of the switch is again combined with the VREF signal and used to control the regulator 210. By using a damped signal the feedback is reduced. Using a similar approach filters and multiple levels of damping could be switched in to form the feedback signal as desired. By including different types of feedback gain the feedback is switchable between very strong feedback, which gives better noise performance, and a fast mode with less feedback gain to allow for faster settling times.

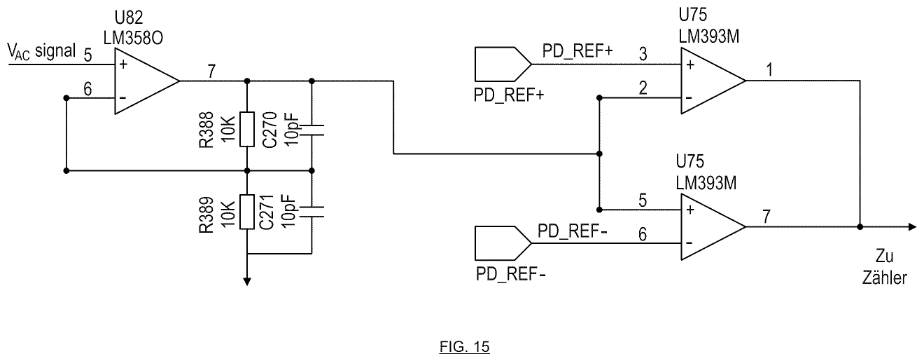

FIG. 15 is circuit diagram of a discharge detector for detecting unwanted electrical discharge in the mass analyser and/or voltage spikes on the feedback signal. The input signal is the signal from the AC feedback path. That is, the input signal may be that received through the HV capacitor C1′ in FIG. 9 or C3 and accompanying resistor R6 in FIG. 10B. The AC signal is first amplified, perhaps with some integration or both P and I parts, and is then passed to operational amplifier U82 in FIG. 15 to buffer the signal. A network of resistors and capacitors may be connected to form a non-inverting configuration. In this example on the feedback path a resistor and capacitor are connected in parallel and another resistor and capacitor are connected to ground. These filter the signal to put it in a good condition for discharge detection. Multiple stages of the non-inverting amplifier configuration comprising operational amplifier U82 may be included although only one stage is shown in FIG. 15. The amplified signal is then fed to a window comparator. The window comparator may have configurable upper and lower trigger levels which may be set by a DAC. The output of the comparator is sent to a counter such as on an FPGA. A window comparator is used instead of a threshold comparator such that it has trigger levels for excess voltage or current for both polarities of operation. The FPGA can count the unwanted discharge events and/or length of time a discharge occurs and either provide an alert to a user, or more preferably drop or leave out spectra with HV instabilities. The counter may additionally or alternatively determine the frequency of discharges to measure how clean the signal is, because some level of discharges may be acceptable. The window comparators may be adjustable to detect the magnitude of the discharges.

We have described in relation to FIG. 8 that two voltages DAC and REF may be used to provide a reference voltage for controlling the regulator transistor. Although not shown in FIGS. 9 and 10A these two voltages may be included in those circuits too. The combination of the two voltages DAC and REF provides a very stable reference source. The same very stable reference source may be used across all regulator circuits M1-M4.

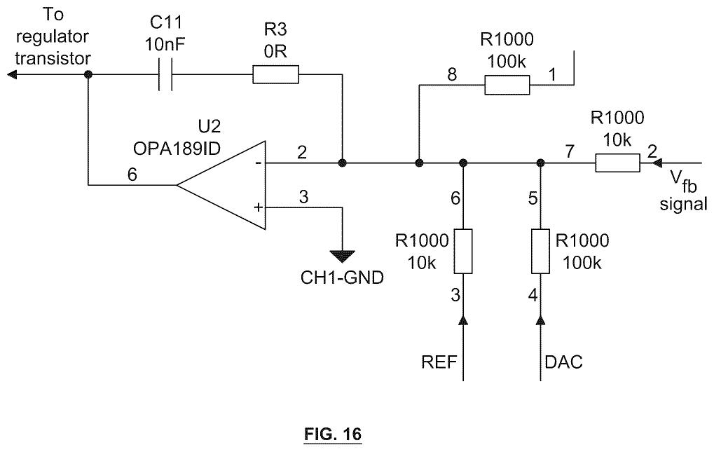

As mentioned, the reference voltage is derived out of two voltages. One reference has a very accurate output (trimmed by the manufacturer) but is too unstable to provide the required ppm voltage stability required by the current application, because of drift, noise and temperature dependent variation. The first reference is combined with a second reference which is stable but not accurate. The output voltage of the second reference varies a lot from component to component but is very stable, that is it has low noise, low drift and low temperature dependent variation. To combine the two references to a single stable and accurate reference a DAC is used. The DAC scales the stable second reference to the same voltage as the accurate first reference. This may be done by logic circuitry in FPGA firmware. More details of the highly stable and accurate reference are described in United Kingdom patent application published as GB 2591297. FIG. 16 shows in more detail, in comparison to FIGS. 8 and 10A, how the DAC and REF voltages are combined with weighting at an operational amplifier U2. The arrangement and weighting into the operational amplifier is similar to that shown for operational amplifier A2 in FIG. 8. The weightings are such that the 10 kΩ resistor feeding the REF signal in comparison to the 100 kΩ resistor feeding the DAC signal means that the REF reference voltage, which is very stable, is fed into the operational amplifier, and then the set value from the DAC is added weighted by a factor of 1/10. This weighting reduces the drift and temperature impact of the DAC by a factor of 10. The feedback signal is fed to the operational amplifier at the same weighting as the REF reference. These references and feedback signal are supplied to operational amplifier which is configured as an adder. A capacitor across the operational amplifier provides some signal integration. A resistor may be included if both proportional and integral parts are required. In FIG. 16 the resistor R3 is set to zero so only integration is provided. The output of the circuit of FIG. 16 is fed to the optocoupler such as U1 in FIG. 10A to control the regulator transistor. Operational amplifier U2 in FIG. 16 corresponds to operational amplifier A2 in FIGS. 8 and U4 in FIG. 10A.

The person skilled in the art will readily appreciate that various modifications and alterations may be made to the above described methods and apparatus. The modifications may be made without departing from the scope of the appended claims. For example, different components may be used and the order of elements in the circuits may be changed.

Embodiments of the present invention are set out in the following clauses:

Clause A1. A multi-reflection time-of-flight, MR-ToF, mass analyser for a mass spectrometer, the MR-ToF mass analyser comprising a plurality of mirror electrodes, a first mirror electrode configured to operate at a first polarity and one or more second mirror electrodes configured to operate at a second polarity opposite to the first polarity, the mass analyser configured for polarity switching and further comprising: a first power source configured to provide a first HV supply; a second power source configured to provide a second HV supply; at least two HV switches; a first regulator coupled to one or more first HV switches, the first regulator configured to provide an electric potential to the first mirror electrode; and one or more second regulators each coupled to one or more second HV switches, each of the one or more second regulators configured to provide an electric potential to a respective second mirror electrode, wherein the first and second HV switches are configured to swap the polarity of electrical potential supplied to the first regulator and the one or more second regulators.

Clause A2. The MR-ToF mass analyser of Clause A1, wherein the first power source is configured in a first bridge configuration, the one or more first HV switches arranged in the first bridge configuration to reverse the coupling of the first power source in the first bridge configuration to swap the polarity of the electrical potential output to the first regulator, and the second power source is configured in a second bridge configuration, the one or more second HV switches arranged in the second bridge configuration to reverse the coupling of the second power source in the second bridge configuration to swap the polarity of the electrical potential output to the one or more second regulators.

Clause A3. The MR-ToF of Clause A2, wherein the first bridge configuration is a H-bridge arrangement and the one or more first HV switches comprise four first HV switches, the first power source coupled at the centre of the H-bridge arrangement and the four first HV switches switchable in two pairs to define a first circuit path coupling the first power source to provide a positive HV voltage to the first regulator and a second circuit path coupling the first power source to provide a negative HV voltage to the first regulator.

Clause A4. The MR-ToF of Clause A2 or Clause A3, wherein the second bridge configuration is a H-bridge arrangement and the one or more second HV switches comprise four second HV switches, the second power source coupled at the centre of the H-bridge arrangement and the four second HV switches switchable in two pairs to define a third circuit path coupling the second power source to provide a positive HV voltage to the one or more second regulators and a fourth circuit path coupling the second power source to provide a negative HV voltage to the one or more second regulators.

Clause A5. The MR-ToF of Clause A3 or Clause A4, wherein the circuit paths are further coupled to ground or virtual ground.

Clause A6. The MR-ToF of any of Clauses A3 to A5, wherein the HV switches of the bridge arrangements are configured to be switchable to decouple the power sources from the regulators.

Clause A7. The MR-ToF of any of Clauses A3 to A5, wherein the HV switches of the bridge arrangements are configured to be switchable to discharge the regulators to ground or virtual ground.

Clause A8. The MR-ToF mass analyser of any of Clauses A1 to A7, wherein the first power source is configured to provide a positive HV supply and the second power source is configured to provide a negative HV supply, the at least two switches comprising a first HV switch and a second HV switch, the first and second HV switches each having an output, wherein the first regulator is coupled to the output from the first HV switch and the one or more second regulators are each coupled to the output from the second HV switch, and the first and second HV switches are configured to switch between the first and second power sources to swap the polarity of electrical potential at the first mirror electrode and the second mirror electrodes.

Clause A9. The MR-ToF mass analyser of any of Clauses A1 to A8, comprising a first voltage pre-scaler arranged to receive the positive or negative HV supply from the first switch and configured to provide a HV output having reduced voltage magnitude to the first regulator.

Clause A10. The MR-ToF mass analyser of any of Clauses A1 to A9, comprising a second voltage pre-scaler arranged to receive the positive or negative HV supply from the second switch and configured to provide respective one or more HV outputs having reduced voltage magnitudes to the one or more second regulators.

Clause A11. The MR-ToF mass analyser of Clause A9 or Clause A10, wherein the first and/or second voltage pre-scaler comprises a chain of bi-polar diodes to step the voltage down in magnitude from the voltage provided by the positive and/or negative HV supply to the reduced voltage magnitudes.

Clause A12. The MR-ToF mass analyser of Clause A11, wherein the second voltage pre-scaler is arranged to provide at least two HV outputs, a first HV output tapped-off from between a first group of bi-polar diodes of the chain of bi-polar diodes and a second group of bi-polar diodes of the chain of bi-polar diodes to step the voltage down to a first voltage magnitude, and a second HV output tapped-off from between the second group of bi-polar diodes of the chain of bi-polar diodes and a third group of bi-polar diodes of the chain of bi-polar diodes or from between the second group of bi-polar diodes of the chain of bi-polar diodes and one or more resistors to step the voltage down to a second voltage magnitude less than the first voltage magnitude.

Clause A13. The MR-ToF analyser of Clause A12, wherein the second voltage pre-scaler is arranged to provide at least three HV outputs, wherein the second HV output is tapped-off from between the second group of bi-polar diodes of the chain of bi-polar diodes and a third group of bi-polar diodes of the chain of bi-polar diodes to step the voltage down to the second voltage magnitude less than the first voltage magnitude, and the third HV output is tapped-off from between the third group of bi-polar diodes of the chain of bi-polar diodes and fourth group of bi-polar diodes of the chain of bi-polar diodes or between the third group of bi-polar diodes of the chain of bi-polar diodes and one or more resistors to step the voltage down to third voltage magnitude less than the second voltage magnitude.

Clause A14. The MR-ToF analyser of any of Clauses A1 to A13, comprising three second mirror electrodes.

Clause B15. A regulator for supplying a regulated HV voltage to an electrode of a mass analyser of a mass spectrometer, the regulator configured for receiving HV voltage of positive or negative polarity, the regulator comprising: an input for receiving a HV voltage from a source; an output for supplying regulated HV voltage to the electrode; one or more reference inputs for receiving one or more reference voltages; a tuning unit for regulating the HV voltage supplied at the output; and a feedback circuit coupled between the output and the tuning unit, the feedback circuit arranged to monitor one or more voltages indicative of the regulated HV voltage supplied at the output, the feedback circuit comprising a first feedback path comprising a capacitor and configured to monitor AC coupled currents on the output and provide a first feedback signal and a second feedback path configured to monitor the DC level on the output and provide a second feedback signal, and the tuning unit regulates the HV output voltage based on the one or more reference voltages and the first and second feedback signals.

Clause B16. The regulator of Clause B15, wherein the tuning unit comprises a MOSFET connected between input and the output.

Clause B17. The regulator of Clause B15 or Clause B16, wherein the first feedback path is configured to filter out DC and/or low frequency leakage currents from the capacitor when the polarity of the HV voltage is switched.

Clause B18. The regulator of any of Clause B15 to B17, wherein the regulator is configured to combine the first and second feedback signals into a combined feedback signal and provide the combined feedback signal to the tuning unit.

Clause B19. The regulator of any of Clauses B15 to B18, further comprising a summing integrator configured to add the one or more reference voltages to the one or more feedback signals and perform integration of the sum.

Clause B20. The regulator of Clause B19, wherein the one or more reference voltages and one or more feedback signals are scaled respectively to each other before adding.

Clause B21. The regulator of any of Clauses B15 to B20, further comprising a bridge rectifier, wherein the tuning unit is coupled within the bridge rectifier such that current from the input to the output flows in the same direction through the tuning unit whether the HV output signal is positive or negative polarity.

Clause B22. The regulator of Clause B21, wherein the feedback circuit is protected from the HV by being coupled to the tuning unit through an isolating coupler, such as an opto-coupler.

Clause B23. The regulator of any of Clauses B15 to B22, further comprising one or more voltage suppression devices connected across the tuning unit to limit the voltage dropped across the tuning unit to a maximum predetermined voltage.

Clause B24. The regulator of Clause B23, wherein the one or more voltage suppression devices are bipolar suppression diodes.

Clause B25. The regulator of Clause B23 or B24, wherein the maximum predetermined voltage is 1000V or less.

Clause B26. The regulator of any of Clauses B15 to B25, wherein the one or more reference voltages are generated from a reference voltage unit, the reference voltage unit comprising: a first voltage reference source configured to provide a first reference voltage; and a second voltage reference source configured to provide a second reference voltage, wherein the first voltage reference source is configured to provide a voltage output more accurate than the second voltage reference source and the second voltage reference source is configured to provide a voltage output more stable than the first voltage reference source.

Clause B27. The regulator of Clause B26, further comprising a digital-to-analogue converter (DAC) to scale the output from the second voltage reference to match the output from the first voltage reference.

Clause B28. The regulator of Clause B18 or any of Clauses B19-B27 when dependent on Clause B18, further comprising a polarity detector configured to detect whether the regulated HV voltage at the output is positive or negative polarity or detect whether the combined feedback signal is positive or negative polarity or detect whether the first feedback signal is positive or negative polarity, and invert the polarity of the combined feedback signal when the HV voltage switches polarity.

Clause B29. The regulator of Clause B28, wherein the polarity detector comprises an analogue switch to switch between the combined feedback signal and a polarity inverted combined feedback signal, the analogue switch being triggered to switch between the polarity inverted combined feedback signal and the combined feedback signal when the regulated HV output switches polarity.

Clause B30. The regulator of any of Clauses B18 to B29, further comprising a discharge detection circuit for detecting a discharge of the HV output voltage based on detecting an increased current flow through the regulator from the combined feedback signal.

Clause B31. The regulator of Clause B30, wherein the discharge detection circuit comprises a window comparator for detecting whether a voltage based on the combined feedback signal is outside a predetermined range.

Clause B32. The regulator of Clause B30 or B31, further comprising an output device for alerting a user that an electrical discharge has occurred when the voltage based on the combined feedback signal is outside the predetermined range.

Clause B33. The regulator of any of Clauses B18 to B32, further comprising a feedback damping circuit comprising a switch for receiving an input to select between a first combined feedback signal and a second combined feedback signal, the first and second combined feedback signals generated from the combined feedback signal, the second signal having more damping than the first, and the selected one of the first and second combined feedback signals being provided to the tuning unit.

Clause C34. The MR-ToF analyser of any of Clauses A1 to A14, wherein any of the first regulator or one or more second regulators comprises the regulator of any of Clauses B15 to B33.

Clause D35. A mass spectrometer comprising the MR-ToF analyser of any of Clauses A1 to A14 or C34, and/or the regulator of any of Clauses B15 to B33.

1. A multi-reflection time-of-flight, MR-ToF, mass analyser for a mass spectrometer, the MR-ToF mass analyser comprising a plurality of mirror electrodes, a first mirror electrode configured to operate at a first polarity and one or more second mirror electrodes configured to operate at a second polarity opposite to the first polarity, the mass analyser configured for polarity switching and further comprising:
a first power source configured to provide a first HV supply;
a second power source configured to provide a second HV supply;
at least two HV switches;
a first regulator coupled to one or more first HV switches, the first regulator configured to provide an electric potential to the first mirror electrode; and
one or more second regulators each coupled to one or more second HV switches, each of the one or more second regulators configured to provide an electric potential to a respective second mirror electrode,
wherein the first and second HV switches are configured to swap the polarity of electrical potential supplied to the first regulator and the one or more second regulators.

2. The MR-ToF mass analyser of claim 1, wherein the first power source is configured in a first bridge configuration, the one or more first HV switches arranged in the first bridge configuration to reverse the coupling of the first power source in the first bridge configuration to swap the polarity of the electrical potential output to the first regulator, and
the second power source is configured in a second bridge configuration, the one or more second HV switches arranged in the second bridge configuration to reverse the coupling of the second power source in the second bridge configuration to swap the polarity of the electrical potential output to the one or more second regulators.

3. The MR-ToF of claim 2, wherein the first bridge configuration is a H-bridge arrangement and the one or more first HV switches comprise four first HV switches, the first power source coupled at the centre of the H-bridge arrangement and the four first HV switches switchable in two pairs to define a first circuit path coupling the first power source to provide a positive HV voltage to the first regulator and a second circuit path coupling the first power source to provide a negative HV voltage to the first regulator.

4. The MR-ToF of claim 2, wherein the second bridge configuration is a H-bridge arrangement and the one or more second HV switches comprise four second HV switches, the second power source coupled at the centre of the H-bridge arrangement and the four second HV switches switchable in two pairs to define a third circuit path coupling the second power source to provide a positive HV voltage to the one or more second regulators and a fourth circuit path coupling the second power source to provide a negative HV voltage to the one or more second regulators.

5. The MR-ToF of claim 3, wherein the circuit paths are further coupled to ground or virtual ground.

6. The MR-ToF of claim 3, wherein the HV switches of the bridge arrangements are configured to be switchable to decouple the power sources from the regulators and/or to discharge the regulators to ground or virtual ground.

7. The MR-ToF mass analyser of claim 1, wherein the first power source is configured to provide a positive HV supply and the second power source is configured to provide a negative HV supply, the at least two switches comprising a first HV switch and a second HV switch, the first and second HV switches each having an output,
wherein the first regulator is coupled to the output from the first HV switch and the one or more second regulators are each coupled to the output from the second HV switch, and the first and second HV switches are configured to switch between the first and second power sources to swap the polarity of electrical potential at the first mirror electrode and the second mirror electrodes.

8. The MR-ToF mass analyser of claim 1, comprising a first voltage pre-scaler and/or a second voltage pre-scaler,
wherein the first voltage pre-scaler is arranged to receive the positive or negative HV supply from the first switch and configured to provide a HV output having reduced voltage magnitude to the first regulator,
wherein the second voltage pre-scaler arranged to receive the positive or negative HV supply from the second switch and configured to provide respective one or more HV outputs having reduced voltage magnitudes to the one or more second regulators.

9. The MR-ToF mass analyser of claim 8, wherein the first and/or second voltage pre-scaler comprises a chain of bi-polar diodes to step the voltage down in magnitude from the voltage provided by the positive and/or negative HV supply to the reduced voltage magnitudes.

10. The MR-ToF mass analyser of claim 9, wherein the second voltage pre-scaler is arranged to provide at least two HV outputs, a first HV output tapped-off from between a first group of bi-polar diodes of the chain of bi-polar diodes and a second group of bi-polar diodes of the chain of bi-polar diodes to step the voltage down to a first voltage magnitude, and a second HV output tapped-off from between the second group of bi-polar diodes of the chain of bi-polar diodes and a third group of bi-polar diodes of the chain of bi-polar diodes or from between the second group of bi-polar diodes of the chain of bi-polar diodes and one or more resistors to step the voltage down to a second voltage magnitude less than the first voltage magnitude.

11. The MR-ToF analyser of claim 10, wherein the second voltage pre-scaler is arranged to provide at least three HV outputs, wherein the second HV output is tapped-off from between the second group of bi-polar diodes of the chain of bi-polar diodes and a third group of bi-polar diodes of the chain of bi-polar diodes to step the voltage down to the second voltage magnitude less than the first voltage magnitude, and the third HV output is tapped-off from between the third group of bi-polar diodes of the chain of bi-polar diodes and fourth group of bi-polar diodes of the chain of bi-polar diodes or between the third group of bi-polar diodes of the chain of bi-polar diodes and one or more resistors to step the voltage down to third voltage magnitude less than the second voltage magnitude.

12. A regulator for supplying a regulated HV voltage to an electrode of a mass analyser of a mass spectrometer, the regulator configured for receiving HV voltage of positive or negative polarity, the regulator comprising:
an input for receiving a HV voltage from a source;
an output for supplying regulated HV voltage to the electrode;
one or more reference inputs for receiving one or more reference voltages;
a tuning unit for regulating the HV voltage supplied at the output; and
a feedback circuit coupled between the output and the tuning unit, the feedback circuit arranged to monitor one or more voltages indicative of the regulated HV voltage supplied at the output, the feedback circuit comprising a first feedback path comprising a capacitor and configured to monitor AC coupled currents on the output and provide a first feedback signal and a second feedback path configured to monitor the DC level on the output and provide a second feedback signal, and
the tuning unit regulates the HV output voltage based on the one or more reference voltages and the first and second feedback signals.

13. The regulator of claim 12, wherein the tuning unit comprises a MOSFET connected between input and the output.

14. The regulator of claim 12, wherein the first feedback path is configured to filter out DC and/or low frequency leakage currents from the capacitor when the polarity of the HV voltage is switched.

15. The regulator of claim 12, wherein the regulator is configured to combine the first and second feedback signals into a combined feedback signal and provide the combined feedback signal to the tuning unit.

16. The regulator of claim 12, further comprising a bridge rectifier, wherein the tuning unit is coupled within the bridge rectifier such that current from the input to the output flows in the same direction through the tuning unit whether the HV output signal is positive or negative polarity.

17. The regulator of claim 12, further comprising one or more voltage suppression devices connected across the tuning unit to limit the voltage dropped across the tuning unit to a maximum predetermined voltage.

18. The regulator of claim 17, wherein the one or more voltage suppression devices are bipolar suppression diodes.

19. The MR-ToF analyser of claim 1, wherein any of the first regulator or one or more second regulators comprises:
a regulator for supplying a regulated HV voltage to an electrode of a mass analyser of a mass spectrometer, the regulator configured for receiving HV voltage of positive or negative polarity, the regulator comprising:
an input for receiving a HV voltage from a source;
an output for supplying regulated HV voltage to the electrode;
one or more reference inputs for receiving one or more reference voltages;
a tuning unit for regulating the HV voltage supplied at the output; and
a feedback circuit coupled between the output and the tuning unit, the feedback circuit arranged to monitor one or more voltages indicative of the regulated HV voltage supplied at the output, the feedback circuit comprising a first feedback path comprising a capacitor and configured to monitor AC coupled currents on the output and provide a first feedback signal and a second feedback path configured to monitor the DC level on the output and provide a second feedback signal, and
the tuning unit regulates the HV output voltage based on the one or more reference voltages and the first and second feedback signals.

20. A mass spectrometer comprising the regulator of claim 12.
